(19) United States
(12) Patent Application Publication
(10) Pub. No.: US 2022/0196994 A1
(43) Pub. Date: Jun. 23, 2022

(54) PROJECTION SYSTEM AND PROJECTOR

(71) Applicant: IVIEW DISPLAYS (SHENZHEN) COMPANY LTD., Shenzhen (CN)

(72) Inventors: Wenxiang Li, Shenzhen (CN); Weizhan Zhu, Shenzhen (CN); Steve Yeung, Shenzhen (CN); Zhiqiang Gao, Shenzhen (CN); Mingnei Ding, Shenzhen (CN)

(21) Appl. No.: 17/535,746

(22) Filed: Nov. 26, 2021

Related U.S. Application Data
(63) Continuation of application No. PCT/CN2021/073785, filed on Jan. 26, 2021.

(30) Foreign Application Priority Data
Dec. 23, 2020 (CN) 202011535606.7

(51) Int. Cl. G02B 13/06; G03B 21/00; G02B 13/16; G03B 21/20; H05B 45/325; H05B 45/10; H04N 9/31

(52) U.S. Cl. CPC G02B 13/06; G03B 21/008; G02B 13/16; G03B 21/2033; H04N 9/3102; H05B 45/325; H05B 45/10; H04N 9/3164; G03B 21/2013

(57) ABSTRACT

The present disclosure provides a projection system and a projector. The projection system includes a control unit, and includes a light source, a fly-eye lens, a DMD chip, and a projection lens that are sequentially disposed along a light path. The light source is configured to supply a projection light source; an aspect ratio of the fly-eye lens is defined as an aspect ratio desired by a projection image, and the fly-eye lens is configured to receive the projection light source, and output a parallel light to the DMD chip; the DMD chip is configured to display projection content; the projection lens is configured to project the projection content to the projection plane; and the control unit is connected to the light source and the DMD chip, and is configured to control the light source to operate and send the projection content to the DMD chip.

### CROSS-REFERENCE TO RELATED APPLICATIONS

This application is a continuation-application of International (PCT) Patent Application No. PCT/CN2021/073785, filed on Jan. 26, 2021, which claims priority to Chinese Patent Application No. 202011535606.7, filed with the National Intellectual Property Administration of China on Dec. 23, 2020, and entitled “PROJECTION SYSTEM AND PROJECTOR”, the entire contents of which are incorporated herein by reference.

### TECHNICAL FIELD

Embodiments of the present disclosure relate to the technical field of digital projection and display, and in particular, relate to a projector system and a projector.

### BACKGROUND

In recent years, with rapid development of semiconductor and display technologies, the projection technology is quickly advanced, and a variety of projectors are available in the market. A core component of a projector, that is, a projection optical engine, is based on the digital light processing (DLP) technology. A resolution of a projection image is determined by a digital micromirror device (DMD), for example, 854*480, 1920*1080, or the like. In this case, an aspect ratio of the projection image is thus determined, for example, 4:3, 16:9, 16:10, or the like.

During practice of the present disclosure, the inventors have found that in the case that an image with an aspect ratio different from that of a DMD chip needs to be projected, generally the image is directly projected by virtue of software. In this case, all micromirrors on the DMD chip operate, emitted light of an LED light source of the projection optical engine may cover all the micromirrors of the DMD chip. However, the image is projected only to part of the region, and in this case, a waste of illumination energy is caused, and luminance of the projection image on a projection plane is low.

### SUMMARY

An embodiment of the present disclosure provides a projection system. The projection system includes a control unit, and includes a light source, a fly-eye lens, a DMD chip, and a projection lens that are sequentially disposed along a light path. The light source is configured to supply a projection light source; an aspect ratio of the fly-eye lens is defined as an aspect ratio desired by a projection image on a projection plane, and the fly-eye lens is configured to receive the projection light source, and output a parallel light having the aspect ratio desired by the projection image to the DMD chip; the DMD chip is configured to display projection content; the projection lens is configured to project the projection content to the projection plane; and the control unit is connected to the light source and the DMD chip, and is configured to control the light source to operate and send the projection content to the DMD chip.

Another embodiment of the present disclosure provides a projector. The projector includes a projection system. The projection system includes a control unit, and includes a light source, a fly-eye lens, a DMD chip, and a projection lens that are sequentially disposed along a light path. The light source is configured to supply a projection light source; an aspect ratio of the fly-eye lens is defined as an aspect ratio desired by a projection image on a projection plane, and the fly-eye lens is configured to receive the projection light source, and output a parallel light having the aspect ratio desired by the projection image to the DMD chip; the DMD chip is configured to display projection content; the projection lens is configured to project the projection content to the projection plane; and the control unit is connected to the light source and the DMD chip, and is configured to control the light source to operate and send the projection content to the DMD chip.

### BRIEF DESCRIPTION OF THE DRAWINGS

One or more embodiments are illustrated by way of example, and not by limitation, in the figures of the accompanying drawings, wherein elements/modules and steps having the same reference numeral designations represent like elements/modules and steps throughout. The drawings are not to scale, unless otherwise disclosed.

FIG. 1 is a schematic structural block diagram of a projection system according to an embodiment of the present disclosure.

FIG. 2 is a schematic structural block diagram of another projection system according to an embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For better understanding of the present disclosure, the present disclosure is described in detail with reference to attached drawings and specific embodiments. Unless the context clearly requires otherwise, throughout the specification and the claims, technical and scientific terms used herein denote the meaning as commonly understood by a person skilled in the art. Additionally, the terms used in the specification of the present disclosure are merely for describing the objectives of the specific embodiments, and are not intended to limit the present disclosure. As used herein, the term “and/or” in reference to a list of one or more items covers all of the following interpretations of the term: any of the items in the list, all of the items in the list and any combination of the items in the list.

It should be noted that, in the absence of conflict, embodiments of the present disclosure and features in the embodiments may be incorporated, which all fall within the protection scope of the present disclosure. In addition, although function module division is illustrated in the schematic diagrams of apparatuses, and in some occasions, module division different from the divisions of the modules in the apparatuses may be used. Further, the terms “first”, “second”, and the like used in this text do not limit data and execution sequences, and are intended to distinguish identical items or similar items having substantially the same functions and effects.

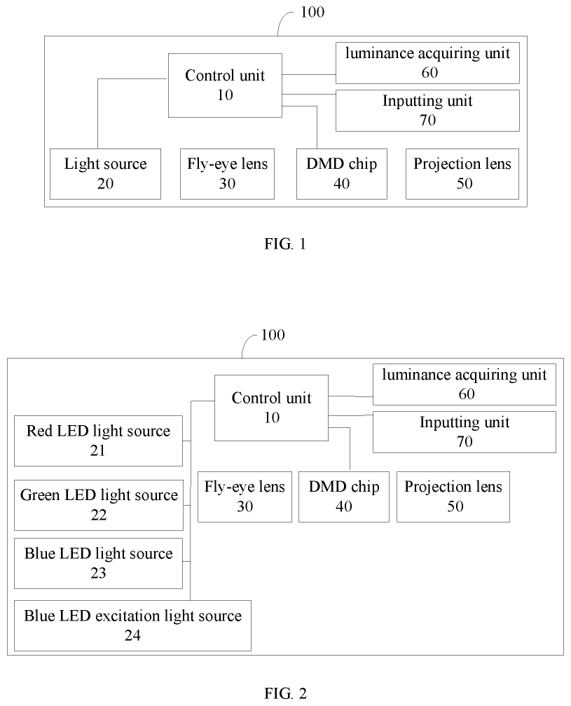

Referring to FIG. 1, FIG. 1 is a schematic structural diagram of a projection system 100 according to an embodiment of the present disclosure. The projection system 100 includes a control unit 10, and includes a light source 20, a fly-eye lens 30, a DMD chip 40, and a projection lens 50 that are sequentially disposed along a light path. The light source 20 is configured to supply a projection light source; an aspect ratio of the fly-eye lens 30 is defined as an aspect ratio desired by a projection image on a projection plane, and the fly-eye lens 30 is configured to receive the projection light source, and output a parallel light having the aspect ratio desired by the projection image to the DMD chip 40; the DMD chip 40 is configured to display projection content; the projection lens 50 is configured to project the projection content to the projection plane; and the control unit 10 is connected to the light source 20 and the DMD chip 40, and is configured to control the light source 20 to operate and send the projection content to the DMD chip 40.

In the projection system 100, by defining the aspect ratio of the fly-eye lens 30 as the aspect ratio desired by the projection image, emitted light of the light source 20 may be confined in a specific region. That is, light output to the DMD chip 40 may be adjusted to be within a range of the aspect ratio desired by the projection image, such that the aspect ratio on the projection plane may be adjusted to a desired aspect ratio. In addition, since the light path of the light source 20 is totally concentrated, via the fly-eye lens 30, onto a central portion of the DMD chip 40, such that illumination of the projection content is improved, and finally luminance of the projection image is improved. In this way, light energy of the light source is subject to no loss, and thus power consumption of the projection system 100 is reduced.

In the case that the aspect ratio of the projection content exceeds the aspect ratio of the fly-eye lens 30, the control unit 10 may process the projection content to adapt to the aspect ratio of the fly-eye lens 30. However, this causes loss of the projection content. For reduction of loss of the projection content and improvement of utilization rate of the light energy, in some embodiments, the aspect ratio of the projection content is made consistent with the aspect ratio of the fly-eye lens 30. In this way, the projection content may be completely presented on the projection plane, and the utilization rate of the light energy irradiated, via the fly-eye lens 30, onto the DMD chip 40 reaches 100%, and thus no waste of the light energy is caused.

Specifically, in some embodiments, in the case that the desired aspect ratio for the projection image is 1:1, the aspect ratio of the fly-eye lens 30 is 1:1, an aspect ratio of the DMD chip 40 is 16:9, and the aspect ratio of the projection image is 1:1. As compared with the related art where the fly-eye lens 20 is not modified, in the case of equal light energy, the light energy is concentrated, via the fly-eye lens 30, within the range of the aspect ratio desired by the projection image, such that an irradiation area of the light on the DMD chip 40 is reduced, illumination of the light source 20 is entirely improved, and finally luminance of the projection image is improved and utilization of the light energy is improved. In practice, the aspect ratio of the fly-eye lens 30 may be defined as the desired aspect ratio, which is not limited to the aspect ratio according to the embodiments of the present disclosure.

Where the projection image only needs to be presented as a grayscale image, in some embodiments, the light source is a white LED light source.

Where the projection image needs to be presented a color image, in some embodiments, referring to FIG. 2, the light source 20 includes a red LED light source 21, a green LED light source 22, a blue LED light source 23, and a blue LED excitation light source 24; and the control unit 10 is connected to the red LED light source 21, the green LED light source 22, the blue LED light source 23, and the blue LED excitation light source 24. Generally, a light conversion rate of the green LED light source 22 is the maximum, reaching 110 lm/W, a light conversion rate of the red LED light source 21 is 34 lm/W, and a light conversion rate of the blue LED light source 23 is the minimum, that is, 22 lm/W. Apparently, the light conversion rate of the blue LED light source 23 is low, and thus a blue LED excitation light source 24 needs to be added. The blue LED excitation light source 24 is capable of causing laser to be irradiated on a blue phosphor layer of the LED, and emit blue light.

In some embodiments, the projection system 100 supports a full-color operating mode and a monochrome operating mode; and the control unit 10 is further configured to control the red LED light source 21, the green LED light source 22, the blue LED light source 23, and the blue LED excitation light source 24 to simultaneously operate, such that the projection system 100 operates in the full-color operating mode; or control one LED light source of the red LED light source 21, the green LED light source 22, the blue LED light source 23, or the blue LED excitation light source 24 to operate, such that the projection system 100 operates in the monochrome operating mode.

However, in the projection system 100, different LED light sources achieve different light emission efficiencies. The light emission efficiency of the red LED light source 21 is about 31%, the light emission efficiencies of the green LED light source 22 and the blue LED light source 23 are about 26%, and the light emission efficiency of the blue LED excitation light source 24 is only 5%. Therefore, an actual light conversion rate of the green LED light source 22 is 28.6 lm/W, an actual light conversion rate of the red LED light source 21 is 10.54 lm/W, and an actual light conversion rate of the blue LED light source 23 is 5.72 lm/W, and an actual light conversion rate of the blue LED excitation light source 24 is 1.1 lm/W. In the case that the four LED light sources have an equal power, an overall light conversion rate is 11.49 lm/W. Apparently, a projection luminance of the projection image at this moment is low.

To improve the projection luminance of the projection image, in some embodiments, the projection system 100 further includes a luminance acquiring unit 60; wherein the luminance acquiring unit 60 is connected to the control unit 10, and is configured to acquire luminance information of the projection image, and send the luminance information to the control unit 10; and the control unit 10 is further configured to acquire an actual luminance value of the projection image based on the luminance information, and increase a duty cycle of a pulse-width modulation signal output to the green LED light source 22 in response to the actual luminance value being less than a minimum value in a predetermined luminance value range, such that the luminance of the projection image is improved, and the actual luminance value of the projection image reaches the predetermined luminance value range; the control unit 10 is further configured to reduce the duty cycle of the pulse-width modulation signal output to the green LED light source 22 in response to the actual luminance value being greater than a maximum value in the predetermined luminance value range, such that the luminance of the projection image is reduced, and the actual luminance value of the projection image reaches the predetermined luminance value range. Since the actual light conversion rate of the green LED light source 22 is the maximum, the luminance of the projection image may be increased or reduced by increasing or reducing the duty cycle of the pulse-width modulation signal output to the LED light source.

In order to improve luminance and reduce the power consumption, the projection system 100 may directly employ a green monochrome operating mode. In this case, only the green LED light source 22 operates. Since the actual light conversion rate of the green LED light source 22 is the maximum, compared with the case that four LED light sources are used to simultaneously work, and the luminance is equal, the duty cycle of the pulse-width modulation signal output to the green LED light source 22 may be increased by the control unit 10 in the green monochrome operating mode to reduce the power, such that power consumption of the projection system 100 may be greatly reduced. For example, assuming that power of each LED light source in the projection system 100 is 5 W, and total power is 20 W, then in combination with the actual conversion rate of each LED light source, a final luminance of the projection system 100 is 229.8 lm. In the case that only the green LED light source 22 is used, the power may be increased to 8 W by increasing the duty cycle of the green LED light source 22; in this case, the final luminance of the projection system 100 is 228.8 lm, and is equivalent to the luminance yielded in the case that four lamps are operating simultaneously, but the power is only 40% of the power in the case that four lamps are operating simultaneously. In the case that the power of the green LED light source 22 is increased to 10 W, the luminance of the projection image is 286 lm, which is significantly higher than the luminance yielded by four lamps operating simultaneously, but the power of the projection system 100 is only half that of four lamps operating simultaneously. Accordingly, in this way, power consumption of the projection system 100 is greatly saved, and a size and complexity of a heat dissipation module are accordingly reduced.

For ease of switching the operating mode of the projection system 100 by a user and improving user experience, in some embodiments, the projection system 100 further includes an inputting unit 70; wherein the inputting unit 70 is connected to the control unit 10, and is configured to receive operating mode information selected by the user, and send the operating mode information to the control unit 10; and the control unit 10 is further configured to control, based on the operating mode information, the light source to operate. In practice, the inputting unit 70 may be a touch display screen, a mouse, a keyboard or keypad, a key, or any other suitable modules for information input, which is not limited herein.

Another embodiment of the present disclosure further provides a projector. The projector includes the lens module as described above. In the projection system, the aspect ratio of the fly-eye lens is defined as the aspect ratio desired by the projection image, such that it is ensured that illumination energy is not wasted on the premise of achieving the aspect ratio desired by the projection image.

The embodiments of the present disclosure provide a projection system and a projector. The projection system includes a control unit, and a light source, a fly-eye lens, a DMD chip, and a projection lens that are sequentially disposed along a light path; wherein the light source is configured to supply a projection light source; an aspect ratio of the fly-eye lens is defined as an aspect ratio desired by a projection image, and the fly-eye lens is configured to receive the projection light source, and output a parallel light to the DMD chip; the DMD chip is configured to display projection content; the projection lens is configured to project the projection content to the projection plane; and the control unit is connected to the light source and the DMD chip, and is configured to control the light source to operate and send the projection content to the DMD chip. In the projection system, the aspect ratio of the fly-eye lens is defined as the aspect ratio desired by the projection image, such that it is ensured that illumination energy is not wasted on the premise of achieving the aspect ratio desired by the projection image.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A projection system, comprising: a control unit; and a light source, a fly-eye lens, a DMD chip, and a projection lens that are sequentially disposed along a light path; wherein
the light source is configured to supply a projection light source;
an aspect ratio of the fly-eye lens is defined as an aspect ratio desired by a projection image on a projection plane, and the fly-eye lens is configured to receive the projection light source, and output a parallel light having the aspect ratio desired by the projection image to the DMD chip;
the DMD chip is configured to display projection content;
the projection lens is configured to project the projection content to the projection plane; and
the control unit is connected to the light source and the DMD chip, and is configured to control the light source to operate and send the projection content to the DMD chip.

2. The projection system according to claim 1, wherein an aspect ratio of the projection content is consistent with the aspect ratio of the fly-eye lens.

3. The projection system according to claim 1, wherein the aspect ratio of the fly-eye lens is 1:1.

4. The projection system according to claim 1, wherein the light source is a white LED light source.

5. The projection system according to claim 1, wherein the light source comprises a red LED light source, a green LED light source, a blue LED light source, and a blue LED excitation light source; wherein the control unit is connected to the red LED light source, the green LED light source, the blue LED light source, and the blue LED excitation light source.

6. The projection system according to claim 5, wherein the projection system supports a full-color operating mode and a monochrome operating mode; wherein
the control unit is further configured to control the red LED light source, the green LED light source, the blue LED light source, and the blue LED excitation light source to simultaneously operate, such that the projection system operates in the full-color operating mode; or control one LED light source of the red LED light source, the green LED light source, the blue LED light source, or the blue LED excitation light source to operate, such that the projection system operates in the monochrome operating mode.

7. The projection system according to claim 5, further comprising a luminance acquiring unit; wherein
the luminance acquiring unit is connected to the control unit, and is configured to acquire luminance information of the projection image, and send the luminance information to the control unit; and
the control unit is further configured to acquire an actual luminance value of the projection image based on the luminance information, and increase a duty cycle of a pulse-width modulation signal output to the green LED light source in response to the actual luminance value being less than a minimum value in a predetermined luminance value range, such that the actual luminance value of the projection image reaches the predetermined luminance value range.

8. The projection system according to claim 7, wherein the control unit is further configured to reduce the duty cycle of the pulse-width modulation signal in response to the actual luminance value being greater than a maximum value in the predetermined luminance value range, and output the pulse-width modulation signal to the green LED light source, such that the actual luminance value of the projection image reaches the predetermined luminance value range.

9. The projection system according to claim 5, further comprising an inputting unit; wherein
the inputting unit is connected to the control unit, and is configured to receive operating mode information selected by a user, and send the operating mode information to the control unit; and
the control unit is configured to control, based on the operating mode information, the light source to operate.

10. A projector, comprising a projection system; wherein the projection system comprises: a control unit; and a light source, a fly-eye lens, a DMD chip, and a projection lens that are sequentially disposed along a light path; wherein
the light source is configured to supply a projection light source;
an aspect ratio of the fly-eye lens is defined as an aspect ratio desired by a projection image on a projection plane, and the fly-eye lens is configured to receive the projection light source, and output a parallel light having the aspect ratio desired by the projection image to the DMD chip;
the DMD chip is configured to display projection content;
the projection lens is configured to project the projection content to the projection plane; and
the control unit is connected to the light source and the DMD chip, and is configured to control the light source to operate and send the projection content to the DMD chip.

11. The projector according to claim 10, wherein an aspect ratio of the projection content is consistent with the aspect ratio of the fly-eye lens.

12. The projector according to claim 10, wherein the aspect ratio of the fly-eye lens is 1:1.

13. The projector according to claim 10, wherein the light source is a white LED light source.

14. The projector according to claim 10, wherein the light source comprises a red LED light source, a green LED light source, a blue LED light source, and a blue LED excitation light source; wherein the control unit is connected to the red LED light source, the green LED light source, the blue LED light source, and the blue LED excitation light source.

15. The projector according to claim 14, wherein the projection system supports a full-color operating mode and a monochrome operating mode; wherein
the control unit is further configured to control the red LED light source, the green LED light source, the blue LED light source, and the blue LED excitation light source to simultaneously operate, such that the projection system operates in the full-color operating mode; or control one LED light source of the red LED light source, the green LED light source, the blue LED light source, or the blue LED excitation light source to operate, such that the projection system operates in the monochrome operating mode.

16. The projector according to claim 14, further comprising a luminance acquiring unit; wherein
the luminance acquiring unit is connected to the control unit, and is configured to acquire luminance information of the projection image, and send the luminance information to the control unit; and
the control unit is further configured to acquire an actual luminance value of the projection image based on the luminance information, and increase a duty cycle of a pulse-width modulation signal output to the green LED light source in response to the actual luminance value being less than a minimum value in a predetermined luminance value range, such that the actual luminance value of the projection image reaches the predetermined luminance value range.

17. The projector according to claim 16, wherein the control unit is further configured to reduce the duty cycle of the pulse-width modulation signal in response to the actual luminance value being greater than a maximum value in the predetermined luminance value range, and output the pulse-width modulation signal to the green LED light source, such that the actual luminance value of the projection image reaches the predetermined luminance value range.

18. The projector according to claim 14, further comprising an inputting unit; wherein
the inputting unit is connected to the control unit, and is configured to receive operating mode information selected by a user, and send the operating mode information to the control unit; and
the control unit is configured to control, based on the operating mode information, the light source to operate.
